(19) United States
(12) Patent Application Publication
(10) Pub. No.: US 2017/0120835 A1
(43) Pub. Date: May 4, 2017

(54) ROOF STORAGE AND MOUNTING SYSTEM FOR UTILITY TERRAIN VEHICLES

(71) Applicant: Silent Drive, Inc., Orange City, IA (US)

(72) Inventors: MARK E. DEJONG, Hospers, IA (US); WALTER W. OLIVER, Granville, IA (US)

(21) Appl. No.: 14/926,690

(22) Filed: Oct. 29, 2015

(51) Int. Cl. B60R 9/058

(52) U.S. Cl. CPC B60R 9/058

(57) ABSTRACT

An improved a roof system is operably connected to a roof structure of a utility terrain vehicle. The roof system is comprised of a roof body having an elongated front portion, a rear portion, and a front lip portion. The rear portion is generally positioned rearwardly from the roof structure of the UTV and has a compartment configured to store objects. A compartment can also be associated with an underside of the front lip portion. The roof system can be removably connected to the UTV. A lockable door can be operably connected to the rear portion and associated with the compartment. The UTV can further include a railing system with a plurality of rails having T-slots, a container having lower portions with T-slots, and a quick-release clamping assembly. The clamping assembly secures the container to at least one of the plurality of rails.

### FIELD OF THE DISCLOSURE

The present disclosure relates generally to storing and anchoring objects. More particularly, but not exclusively, the present disclosure relates to a system for storing objects within and/or anchoring objects to a roof of a vehicle such as utility terrain vehicle, all-terrain vehicle, and golf cart.

### BACKGROUND OF THE DISCLOSURE

Utility terrain vehicles (UTVs) and other similar vehicles (e.g., all-terrain vehicles (ATVs), golf carts, etc.) provide versatility in a variety of applications. The applications range from light-duty, work-related use by farmers and other laborers when heavier machinery is unnecessary, to recreational uses for outdoor enthusiasts for various sport and leisure activities. Both work-related and recreational uses often are associated with transporting cargo and/or accessories. For example, a laborer might wish to securely transport tools, and a recreational hunter may wish to transport binoculars, firearms, ammunition, spotting scope, fishing poles, miscellaneous gear, lunch, and the like. To that end, UTVs typically have a flatbed area akin to the bed of a pick-up truck.

FIG. 1 illustrates an exemplary UTV 10. The flatbed area 12 is typically disposed rearwardly from an interior 14 of the UTV 10. The flatbed area 12 is adapted to store and/or transport objects. The flatbed area 12 can include walls within which the objects are place. In other instances, the flatbed area 12 can include a railing system or other means to anchor objects to the flatbed area 12. One exemplary railing system is disclosed in U.S. patent application Ser. No. 14/739,749 to DeJong et al., which is incorporated by reference in its entirety.

Being limited to transporting objects in the flatbed area is deficient in several respects. First, the flatbed area is generally inaccessible from the interior of the UTV. Thus, to retrieve an object from the flatbed area, a user often must stop the UTV and exit the interior of the UTV. Therefore, a need exists in the art for one or more storage compartments that are conveniently accessible from within the interior of the UTV.

Second, the flatbed area is typically exposed to the environment. Thus, depending on the use and/or type of storage containers, valuables and other equipment being transported can be undesirably exposed to inclement weather, including rain, snow and other precipitation. Similarly, the interior of the UTV may not have a roof or other structure to limit environmental exposure of the user of the UTV. Therefore, a further need exists in the art to concurrently address these deficiencies and provide a roof structure that limits the environmental exposure of both the interior of the UTV and the objects being stored and/or transported. A still further need exists in the art for roof structure that has at least one lockable compartment to protect valuables.

Third, depending on the size of the flatbed area and/or the amount of objects to be stored and/or transported, a user may wish for additional storage capacity. For example, the flatbed area may be used to store camping gear such as tents, food, and the like, but the user may also want to transport canoe(s), kayak(s), bike(s), and the like. Therefore, a need exists in the art for a roof structure with additional storage capacity. The storage means associated with the roof structure can be multi-functional so as to permit attachment of any number of accessories, including fog lights, soft game lights, flood lights, emergency lights, game baskets, gun racks, a shooting platform, spotting scope mounts, fishing pole holders, lockable tubes, canoe carriers, and/or kayak carriers. The storage means should be reconfigurable to the needed application with minimal time and effort, designed to anchor heavier and/or larger cargo, and effectively secure cargo and/or accessories in demanding off-road terrain.

### SUMMARY OF THE DISCLOSURE

It is therefore a primary object, feature, and/or advantage of the present disclosure to improve on or overcome the deficiencies in the art.

It is another object, feature, and/or advantage of the present disclosure to provide storage compartment(s) that are conveniently accessible from within the interior of the UTV.

It is yet another object, feature, and/or advantage of the present disclosure to provide a roof structure that limits the environmental exposure of both the interior of the UTV and the objects being stored and/or transported.

It is still yet another object, feature, and/or advantage of the present disclosure to effectively secure cargo and/or accessories in demanding off-road terrain.

It is another object, feature, and/or advantage of the present disclosure to protect valuables within lockable storage compartment(s).

It is still another object, feature, and/or advantage of the present disclosure to provide storage capacity in addition to the flatbed area of the UTV. The storage means should be reconfigurable to the needed application with minimal time and effort and designed to anchor heavier and/or larger cargo.

These and/or other objects, features, and advantages of the present disclosure will be apparent to those skilled in the art. The present disclosure is not to be limited to or by these objects, features and advantages. No single embodiment need provide each and every object, feature, or advantage.

According to an aspect of the disclosure, a roof system is operably connected to a roof structure of a UTV. The roof system is comprised of a roof body having an upper surface, an elongated front portion, and a rear portion. The elongated front portion has a lower surface opposite the upper surface of the roof body. The rear portion is generally positioned rearwardly from the roof structure of the UTV and has a compartment configured to store objects. The roof body can be further comprised of a front lip portion extending forwardly and downwardly from the front portion and generally positioned forwardly from the roof structure of the UTV. A shelf can be associated with an underside of the front lip portion. The roof system can be removably connected to the UTV.

The compartment can be enclosed within the rear portion and configured to be accessed through an opening in at least one of opposing sidewalls of the rear portion. A door can be operably connected to the rear portion and associated with the opening. The roof system can be further comprised of a plurality of elongated rails connected to the upper surface of the roof body. The elongated rails are configured to secure objects to the roof of the UTV. Each of the elongated rails can have a T-slot.

According to another aspect of the disclosure, a UTV is comprised a chassis disposed on four wheels, a body frame disposed on the chassis, and a plurality of frame members extending upwardly from the body frame. One or more roof members are connected to at least two of the plurality of frame members. A roof body is connected to the one or more roof members. The roof body is configured to cover an interior of the UTV. The UTV includes at least one storage compartment associated with the roof body.

The UTV can be further comprised of a railing system having a plurality of rails having T-slots, a container having lower portions with T-slots, and a clamping assembly having a plurality of members configured to removably connect to the T-slots of the rails and the T-slots of the lower portions of the container. The clamping assembly secures the container to at least one of the rails.

The storage compartment can be disposed within a rear portion positioned rearwardly from the interior of the UTV. The roof body can further include an elongated front portion extending forwardly from the rear portion and generally positioned above the interior of the UTV. The roof body can still further include a lip portion extending forwardly and downwardly from the elongated front portion. A shelf can be associated with an underside of the lip portion and configured to store objects.

According to yet another aspect of the disclosure, a roof device is configured to operably connect above and cover an interior of a vehicle. The device includes a roof body having at least two storage areas configured to store objects, and further includes a plurality of rails connected to an upper surface of the roof body. Each of the plurality of rails is configured to receive a clamping member to secure objects to the vehicle. The vehicle can be a UTV.

### BRIEF DESCRIPTION OF THE DRAWINGS

Illustrated embodiments of the disclosure are described in detail below with reference to the attached drawing figures, which are incorporated by reference herein, and where:

FIG. 1 is a perspective view of a UTV in accordance with an illustrative embodiment;

FIG. 2 is a perspective view of a UTV with roof system in accordance with an illustrative embodiment;

FIG. 3A is a perspective view of a roof system in accordance with an illustrative embodiment;

FIG. 3B is a perspective view of a roof system in accordance with an illustrative embodiment;

FIG. 4A is a cross-sectional view of the roof system of FIG. 3B, taken along section lines 4A-4A, showing a storage compartment in accordance with an illustrative embodiment;

FIG. 4B is a cross-sectional view of the roof system of FIG. 3B, taken along section lines 4B-4B, showing a storage compartment in accordance with an illustrative embodiment;

FIG. 5A is a detailed view of the railing system of FIG. 3A within circle 5A-5A;

FIG. 5B is a detailed view of the railing system of FIG. 3B within circle 5B-5B;

FIG. 6 is a side elevation view of a railing system and storage container in accordance with an illustrative embodiment; and

FIG. 7 is a perspective view of a clamping assembly in accordance with an illustrative embodiment.

### DETAILED DESCRIPTION

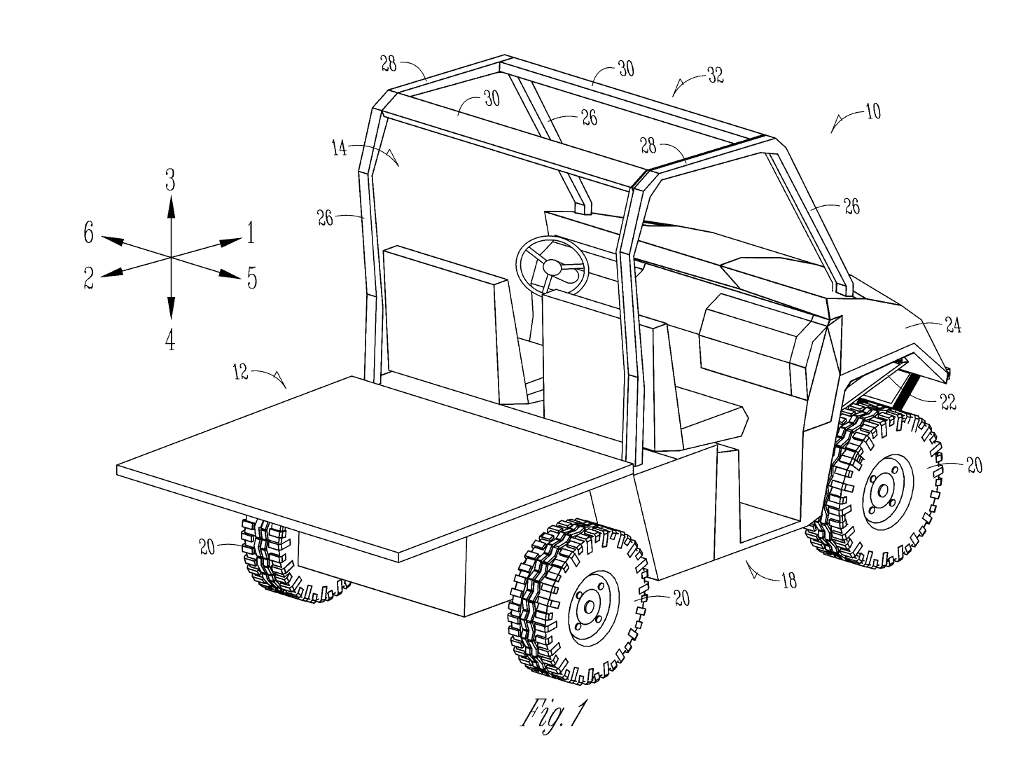

Referring to FIG. 1, the terms “forwardly,” as used herein, is in a direction towards the front of the vehicle 10 in the general direction of reference numeral 1; the term “rearwardly,” as used herein, is in a direction towards the rear of the vehicle 10 in the general direction of reference numeral 2; the term “upwardly,” as used herein, is in a direction towards the top of the vehicle 10 in the general direction of reference numeral 3; and the term “downwardly,” as used herein, is in a direction towards the bottom of the vehicle 10 in the general direction of reference numeral 4; the term “rightwardly,” as used herein, is in the general direction of reference numeral 5; and the term “leftwardly,” as used herein, is in the general direction of reference numeral 6.

FIG. 1 illustrates an exemplary vehicle 10 with which a roof system of the present disclosure can be implemented. The exemplary embodiment preferably is a UTV, but the present disclosure contemplates other vehicles such as ATVs, golf carts, and the like, upon which the roof system can be mounted. The UTV 10 of FIG. 1 includes a chassis 18 disposed on a plurality of wheels 20, most often four wheels. A body frame 22 is connected to the chassis 18 and provides the skeleton for the cabin 24 and other weightbearing structures of the UTV 10.

A plurality of frame members 26 can extend generally upwardly from the body frame 22 and comprise a portion of the roof structure 32. The frame members 26 can include front and rear frame members connected by top frame members 28. One or more cross-members, or roof members 30, can be connected to the plurality of frame members 26, and more particularly the opposing frame members 26, as illustrated in FIG. 1. One of the roof members 30 can be connected generally forwardly from the interior 14 and another one of the roof members 30 can be connected generally rearwardly from the interior 14. The roof members 30 and the top frame members 28 associated with the opposing sides can comprise a square or a rectangular roof structure 32, the latter of which is illustrated in FIG. 1.

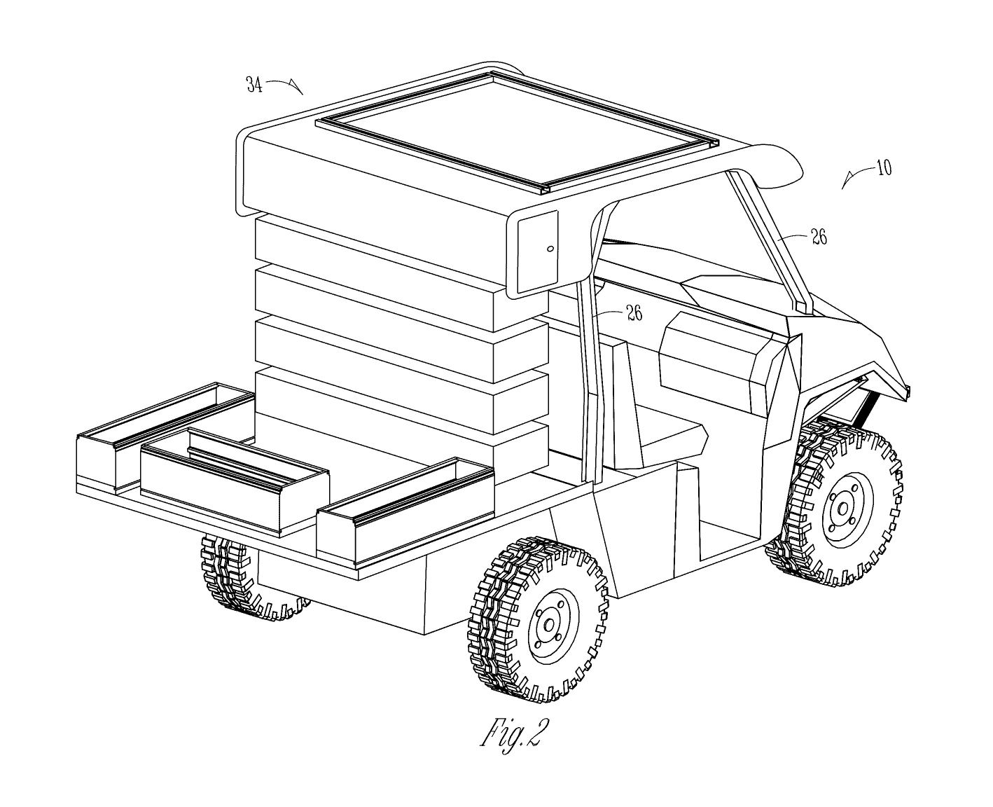

Referring to FIG. 2, an exemplary roof system 34 of the present disclosure is mounted on the UTV 10. In particular, the roof system 34 can be rigidly connected to one or more top frame members 28 and/or roof members 30. The means for connecting the roof system 34 to the roof structure 32 can be accomplished through any means commonly known in the art. In a preferred embodiment, brackets (not shown) associated with a lower surface of the roof system 34 can be secured to the roof structure 32. Other connective means include clamping, welding, detent pins, braces, interference fit, and the like. In an exemplary embodiment, the roof system 34 is constructed aftermarket and configured to mount on any number of models of UTVs. In another exemplary embodiment, the roof system 34 is designed and constructed along with the UTV 10 during manufacturing. In still another exemplary embodiment, the roof system 34 is removably installed on the UTV 10 such that the roof system 34 can be quickly and efficiently installed and uninstalled for any number of reasons.

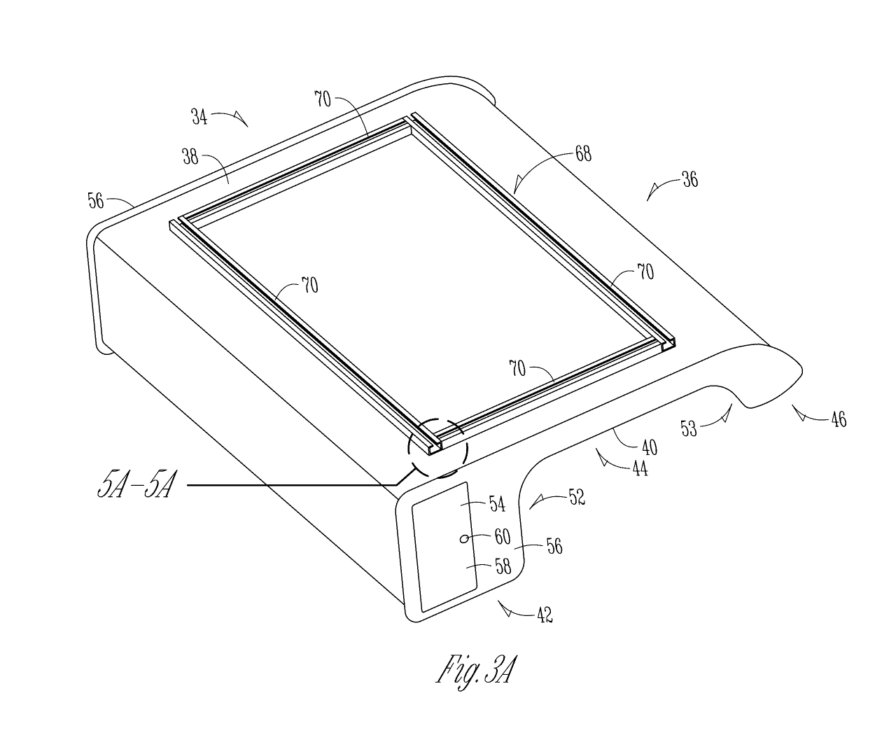

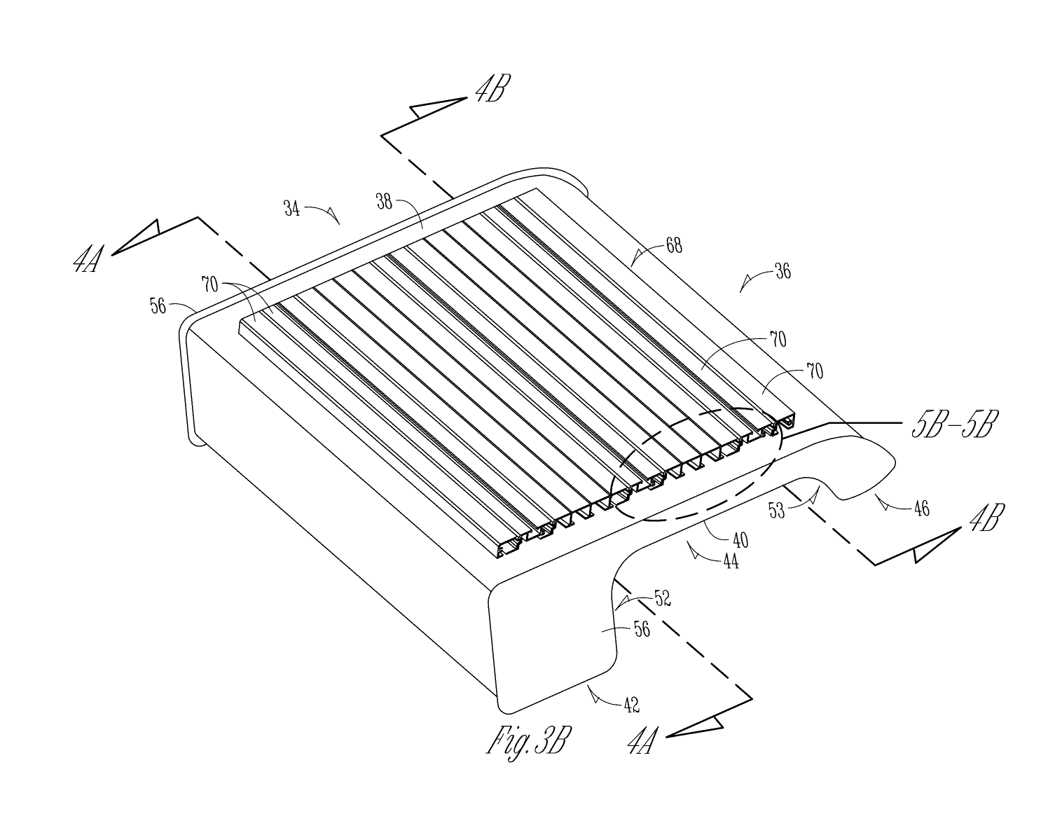

FIGS. 3A and 3B each show exemplary roof systems 34 in accordance with illustrative embodiments. The roof system 34 can include a roof body 36 having an upper surface 38 opposite a lower surface 40. The roof body 36 can further include a rear portion 42, an elongated front portion 44 generally extending forwardly from the rear portion 42, and a front lip portion 46 generally extending forwardly from the elongated front portion 44. The rear portion 42, elongated front portion 44, and front lip portion 46 can be of unitary construction, but the present disclosure contemplates the portions can be separately manufactured and rigidly connected. The roof body 36 can be constructed from a polymer, metal and/or other material of suitable strength and rigidity without deviating from the objects of the present disclosure. The roof body 36 is configured to cover the interior 14 of the UTV 10 so as to shield the interior 14 and users from environmental elements.

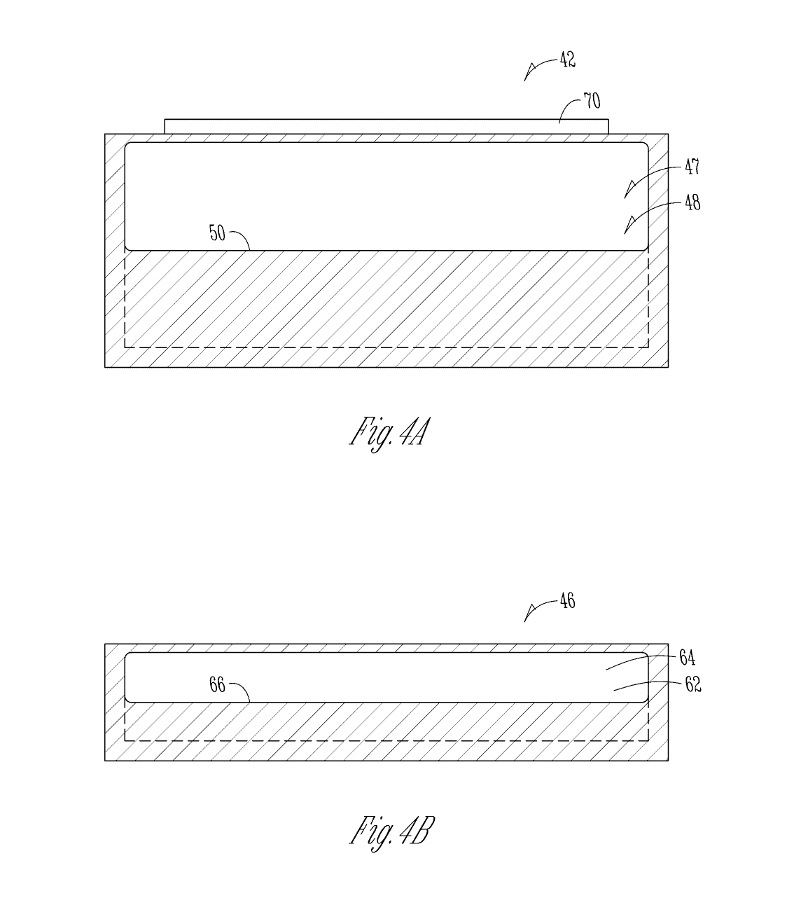

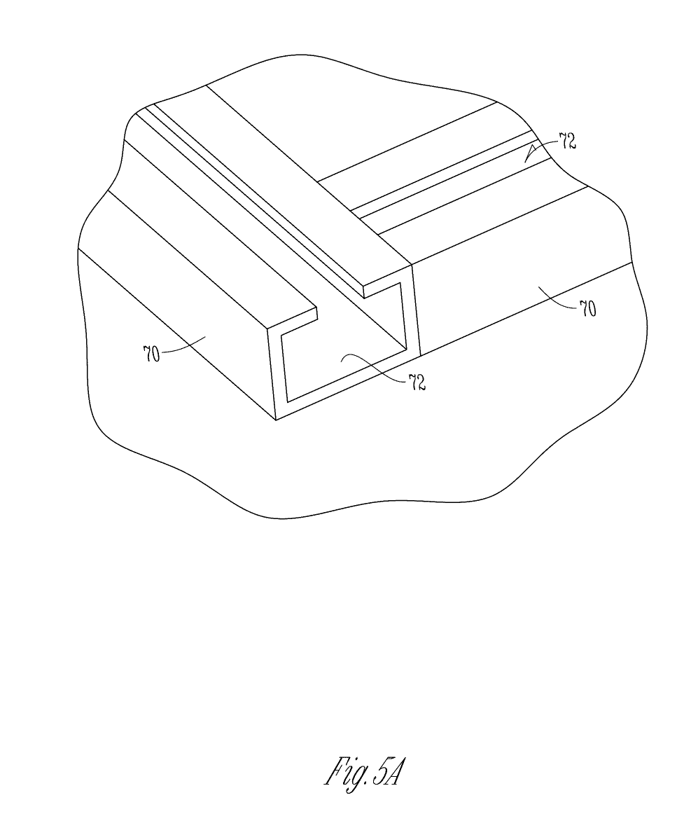

The rear portion 42 can generally be positioned rearwardly from the roof structure 32 of the UTV 10. Furthermore, the rear portion 42 can extend generally downwardly behind the roof structure 32 of the UTV 10, as illustrated in FIG. 2. Doing so can provide user access to a storage compartment 47 associated with the rear portion 42 of the roof system 34 from within the interior 14 of the UTV 10. Referring to FIGS. 3B and 4A, the storage compartment 47 associated with the rear portion 42 can include a shelf 48 integrally formed within the rear portion 42 and facing the interior 14. The shelf 48 can be concave and include an upwardly extending lip 50 to secure objects while the UTV 10 is in operation. The concave shelf 48 can extend substantially along a width of the roof body 36, and more particularly along a width of an underside 52 of the rear portion 42 of the roof body 36.

In another exemplary embodiment illustrated in FIG. 3A, the storage compartment 47 is encased within the rear portion 42 and configured to be accessed through an opening 54 in at least one of opposing sidewalls 56 of the rear portion 42. In such a configuration, a door 58 can be operably connected to the rear portion 42 to selectively close the opening 54. The door 58 can include a lock 60, but the present disclosure contemplates is not so limited. For example, the opening 54 can alternatively include walls, railings, netting, and the like, extending upwardly from the bottom of the opening 54 to prevent objects from falling out of the opening 54.

The front lip portion can generally be positioned forwardly from the roof structure 32 of the UTV 10. The front lip portion 46 can extend generally downwardly in front the roof structure 32 of the UTV 10, as illustrated in FIG. 2. Doing so can provide user access to a storage compartment 62 associated with the rear portion 42 of the roof system 34 from within the interior 14 of the UTV 10. Referring to FIGS. 3B and 4B, the storage compartment 62 associated with the front lip portion 46 can include a shelf 64 integrally formed within the front lip portion 46 and facing the interior 14. The shelf 64 can be concave and include an upwardly extending lip 66 to secure objects while the UTV 10 is in operation. The concave shelf 64 can extend substantially along a width of the roof body 36, and more particularly along a width of an underside 53 of the front lip portion 46 of the roof body 36. Thus, the roof system 34 can be comprised of at least two storage compartments configured to store objects. In certain exemplary embodiments where each of the two storage compartments comprise concave shelves, the storage compartments are accessible from the interior 14 of the UTV 10, providing increased convenience to the user. Further, in other exemplary embodiment having a fully or partially enclosed storage compartment associated with the lockable door 60, the user may enjoy improved security of his or her articles.

For additional storage, a railing system 68 can be associated with the upper surface 38 of the roof body 34. Referring to FIGS. 3A and 3B, the railing system 68 can be comprised of a plurality of elongated rails 70. In the illustrated exemplary embodiment of FIG. 3A, the plurality of elongated rails 70 comprises four rails generally arranged in a rectangle. The present disclosure contemplates any number and/or configuration of the plurality of elongated rails 70. For example, the plurality of rails 70 can be parallel (either forewardly-to-rearwardly or leftwardly-to-rightwardly) and spaced at regular intervals. For another example, the plurality of rails 70 can be comprised of multiple, smaller rectangles or squares disposed inside one another.

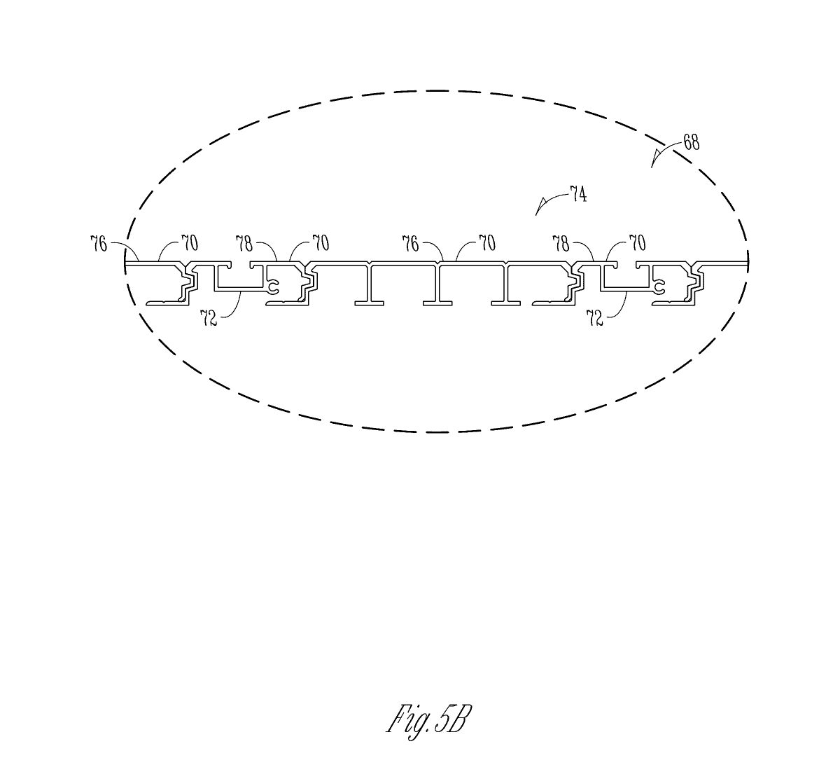

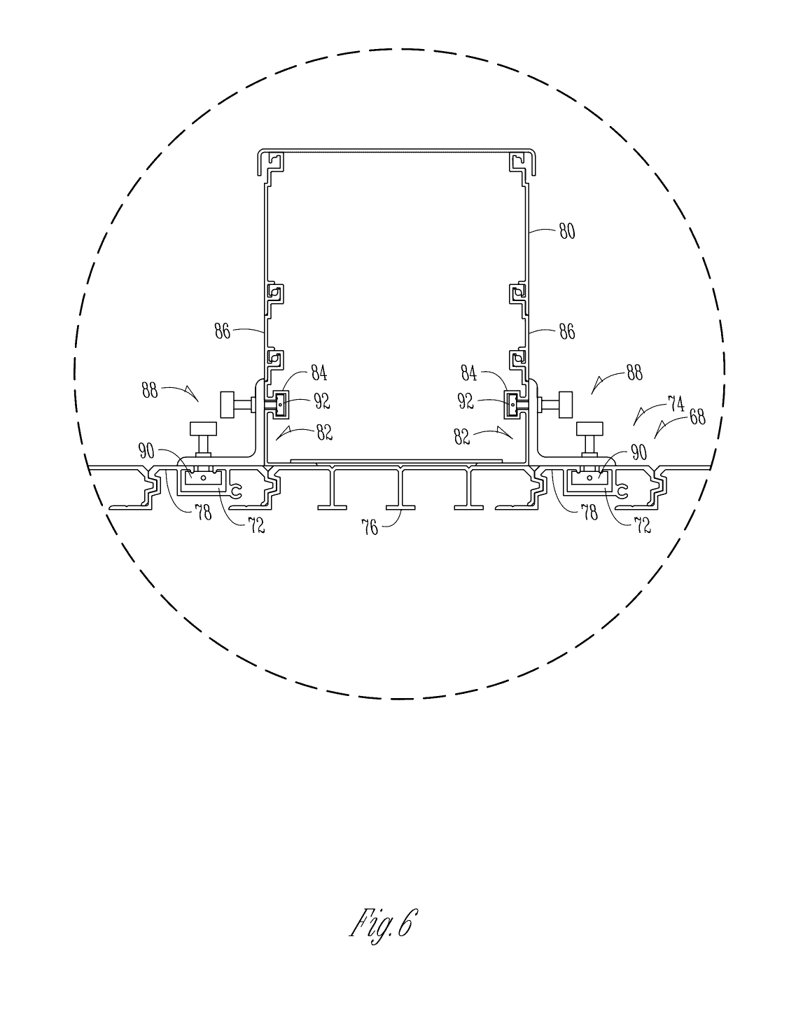

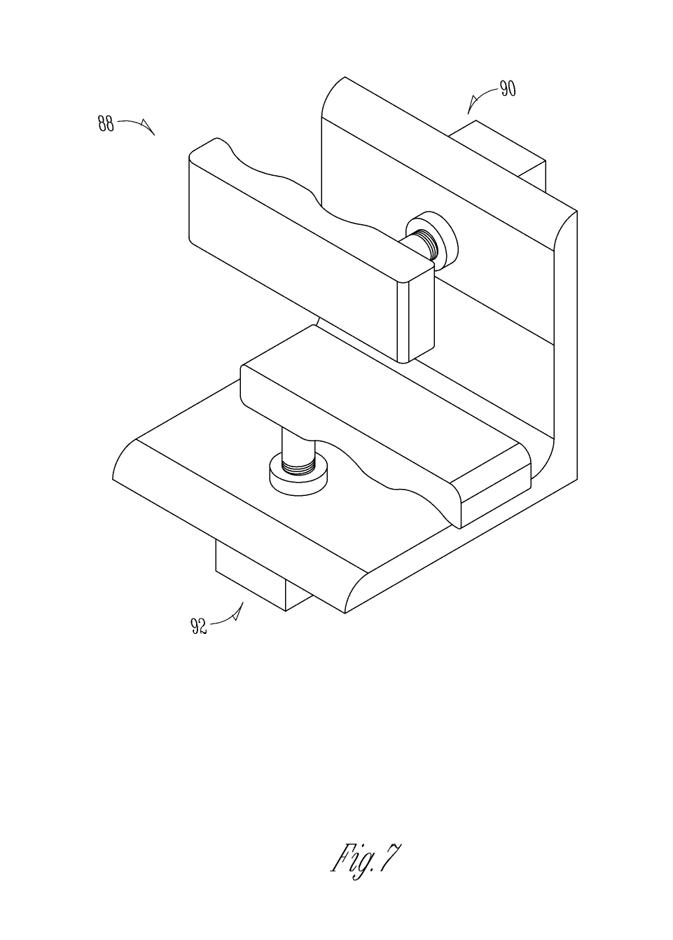

FIG. 5A is detailed view of a portion of the railing system 68 of FIG. 3A. Each of the plurality of elongated rails 70 can include a slot, and more particularly, a T-slot 72. The T-slot 72 can extend along a length of each of the plurality of rails 70. The T-slot 72 can be configured to operably connect to a clamping member 88 (FIG. 6) associated with a quick-connect container system, which is discussed below.

FIG. 6A is a detailed view of a portion of the railing system 68 of FIG. 3B. The railing system 68 illustrated in FIG. 3B is further disclosed in U.S. patent application Ser. No. 14/739,749 to DeJong et al., which is incorporated by reference in its entirety. A deck surface 74 can be comprised of a plurality of guide rails 76 and a plurality of slotted rails 78. The plurality of slotted rails 78 can be oriented parallel to the plurality of guide rails 76. In an exemplary embodiment, the plurality of guide rails 76 and the plurality of slotted rails 78 are parallel and extend substantially between opposing sides of the roof body 36. A slot 72 can be associated with each of the slotted rails 78. As illustrated in FIG. 5B, the slot 72 is T-shaped and can serve as the primary connective means for the clamping assembly 88 (FIG. 6). Based on the unique design of the plurality of guide rails 76 and the plurality of slotted rails 78, the deck surface 74 can be substantially planar and provide an improved surface on which to arrange box-shaped storage containers.

Referring to FIG. 6, a storage receptacle 80 (or container) can be secured to the deck surface 74. An exemplary storage receptacle 80 can include a lower portion 82 having at least one channel 84. In the illustrated embodiment, the channels 84 are T-slots and extend inwardly from a lower portion 82 of each of the opposing sidewalls 86 of the storage receptacle 80. In a preferred embodiment, the T-slotted channels 84 associated with the lower portion 82 of the storage receptacle 80 is sized and shaped to match the T-slots 72 associated with the plurality of slotted rails 78 of the railing system 68.

A clamping assembly 88 secures the storage receptacle 80 to the deck surface 74. As illustrated in FIGS. 6 and 7, the clamping assembly 88 can have a first locking member 90 (or first clamping portion) disposed within the slot 72 of the slotted rail 78 and a second locking member 92 (or second clamping portion) disposed within the T-slotted channel 84 of an opposing sidewall 86 of the storage receptacle 80. The first locking member 90 and/or the second locking member 92 can be comprised of handles, shafts, springs, nuts and clamping bodies. The combination of the handles, shafts and springs can comprise a spring-loaded, quick-release clamp assembly 88, whereby turning the handle for less than a full revolution fully locks the clamp assembly 88. The clamping assembly 88 of the present disclosure is adapted to operably connect to both the embodiments of the railing systems 68 illustrated in FIGS. 3A and 3B.

The roof system 34 of the present disclosure provides secure, additional storage for UTVs and similar vehicles 10. The storage compartments are conveniently placed to be accessible from the interior 14 of the UTV 10. The roof system 34 at least partially protects the user and the stored objects from adverse environmental exposure.

The disclosure is not to be limited to the particular embodiments described herein. In particular, the disclosure contemplates numerous variations in the type of ways in which embodiments of the disclosure can store objects within a roof and/or anchor cargo and other items to the roof of a vehicle. The foregoing description has been presented for purposes of illustration and description. It is not intended to be an exhaustive list or limit any of the disclosure to the precise forms disclosed. It is contemplated that other alternatives or exemplary aspects that are considered included in the disclosure. The description is merely examples of embodiments, processes or methods of the disclosure. It is understood that any other modifications, substitutions, and/or additions can be made, which are within the intended spirit and scope of the disclosure. For the foregoing, it can be seen that the disclosure accomplishes at least all that is intended.

The previous detailed description is of a small number of embodiments for implementing the disclosure and is not intended to be limiting in scope. The following claims set forth a number of the embodiments of the disclosure with greater particularity.

What is claimed is:

1. A roof system operably connected to a roof structure of a utility terrain vehicle (UTV), the system comprising:
a roof body having an upper surface and further comprising:
(a) an elongated front portion having a lower surface opposite the upper surface of the roof body; and
(b) a rear portion generally positioned rearwardly from the roof structure of the UTV and opposite the upper surface, the rear portion having a compartment configured to store objects.

2. The system of claim 1 wherein the roof body further comprises:
a front lip portion extending forwardly and downwardly from the front portion and generally positioned forwardly from the roof structure of the UTV; and
a shelf associated with an underside of the front lip portion.

3. The system of claim 2 wherein the shelf is integrally formed with the front lip portion.

4. The system of claim 1 wherein the roof system is removably connected to the UTV.

5. The system of claim 1 wherein the compartment is a concave shelf associated with an underside of the rear portion and accessible from an interior of the UTV.

6. The system of claim 1 wherein the compartment is enclosed within the rear portion and configured to be accessed through an opening in at least one of opposing sidewalls of the rear portion.

7. The system of claim 6 further comprising a door operably connected to the rear portion and associated with the opening.

8. The system of claim 1 further comprising:
a plurality of elongated rails connected to the upper surface of the roof body; and
wherein the plurality of elongated rails are configured to secure objects to the roof of the UTV.

9. The system of claim 8 wherein each of the plurality of elongated rails further comprises a T-slot extending along a length of the plurality of rails.

10. The system of claim 9 wherein the T-slot is configured to operably connect to a clamping member associated with a quick-connect container system.

11. A utility terrain vehicle (UTV) comprising:
a chassis disposed on four wheels;
a body frame disposed on the chassis;
a plurality of frame members extending upwardly from the body frame;
one or more roof members connected to at least two of the plurality of frame members;
a roof body connected to the one or more roof members, the roof body configured to cover an interior of the UTV; and
at least one storage compartment associated with the roof body to allow storage of items near the roof members of the UTV.

12. The UTV of claim 11 further comprising a railing system comprising:
(a) a plurality of rails having T-slots;
(b) a container having lower portions with T-slots;
(c) a clamping assembly having a plurality of members configured to removably connect to the T-slots of the plurality of rails and the T-slots of the lower portions of the container; and
wherein the clamping assembly secures the container to at least one of the plurality of rails.

13. The UTV of claim 11 wherein the at least one storage compartment is disposed within a rear portion positioned rearwardly from the interior of the UTV.

14. The UTV of claim 13 further comprising a lockable door operably connected to the rear portion of the roof body and configured to selectively provide access to the at least one storage compartment.

15. The UTV of claim 14 wherein the roof body further comprises an elongated front portion extending forwardly from the rear portion and generally positioned above the interior of the UTV.

16. The UTV of claim 15 wherein the roof body further comprises:
a lip portion extending forwardly and downwardly from the elongated front portion; and
a shelf associated with an underside of the lip portion and configured to store objects.

17. The UTV of claim 13 wherein the at least one storage compartment disposed within the rear portion is a shelf associated with an underside of the rear portion and accessible from the interior of the UTV.

18. The UTV of claim 12 wherein the plurality of rails of the railing system further comprises four rails generally arranged in a rectangle or square.

19. The UTV of claim 16 wherein the rear portion, the elongated front portion, and the lip portion are of unitary construction.

20. A roof device configured to operably connect above and cover an interior of a vehicle, the device comprising:
a roof body having at least two storage areas configured to store objects; and
a plurality of rails connected to an upper surface of the roof body, each of the plurality of rails configured to receive a clamping member to secure objects to the vehicle.

21. The roof device of claim 20 wherein the vehicle is a utility terrain vehicle.
